(19) United States
(12) Patent Application Publication
(10) Pub. No.: US 2002/0078529 A1
(43) Pub. Date: Jun. 27, 2002

(54) Spring-loaded hinge and damping arrangement, specifically for a spring-loaded hinge

(75) Inventor: Helmut Schwarz, Weil der Stadt (DE)

Correspondence Address: GREENBLUM & BERNSTEIN, P.L.C., 1941 ROLAND CLARKE PLACE, RESTON, VA, 20191, US

(73) Assignee: SCHWARZ Verbindungs-Systeme GmbH, Althengstett (DE)

(21) Appl. No.: 10/014,374

(22) Filed: Dec. 14, 2001

(30) Foreign Application Priority Data
Dec. 23, 2000 (DE) 200 21 956.1

(51) Int. Cl. E05F 1/14

(52) U.S. Cl. 16/387

(57) ABSTRACT

Hinge having a fixed hinge leaf and a moving hinge leaf, each leaf being provided with at least one pivot bearing and a hinge pivot common to the hinge leafs. The hinge pivot is in the form of a hollow pivot. The hollow pivot is connected non-turnably with the moving hinge leaf and is located turnably in the pivot bearing of the fixed hinge leaf. A torsion spring is located in the hollow pivot, whose torsional force acts in one direction of hinge movement, the hollow pivot and the torsion spring being adapted to be inserted as a single component into the pivot bearings of both hinge leafs. The torsion spring is located in the hollow pivot in a pre-tensioned state so as to constitute a force-actuated connection with an inner wall of the hollow pivot.

### CROSS-REFERENCE TO RELATED APPLICATIONS

The present application claims priority under 35 U.S.C. § 119 of German Patent Application 200 21 956.1, filed Dec. 23, 2000, the disclosure of which is expressly incorporated by reference herein in its entirety.

### BACKGROUND OF THE INVENTION

1. Field of the Invention

The invention concerns a spring-loaded hinge and a damping arrangement for a rotation movement, specifically for a spring-loaded hinge.

2. Discussion of Background Information

Many hinges which possess a spring and a damping arrangement are known in the prior art.

The present invention is intended preferably for use with luggage compartments in aircraft. Luggage compartments of this kind are fitted with doors which serve to close the compartment. These doors are joined to the compartments by means of hinges. The doors of the luggage compartments must be easy to open. This is achieved by the force of a spring which assists the opening movement.

To prevent the door from being opened too quickly, the hinges are fitted with a damping arrangement.

A hinge of this kind where the movement is damped, is known to prior art, e.g. in German utility model no. 298 08 910.6.

FIGS. 12A, 12B and 12C show schematic perspective drawings of a hinge according to the prior art. FIG. 12A shows a schematic perspective drawing of the assembled hinge according to the prior art. FIG. 12B shows a schematic perspective drawing of a hinge pivot 10′ designed partially as a hollow pivot with two damping wings 10-1′ and 10-2′ at the end of a hinge pivot 3′, and of an appropriate damping chamber 11-3′ and of a closing base 12′, 13′ and 14′ for a damping-chamber. FIG. 12C shows a schematic perspective drawing of the hinge pivot 3′ designed partially as a hollow pivot and a spiral torsion spring 4′.

This hinge comprises a fixed hinge leaf 2′ and a moving hinge leaf 1′ with a hollow pivot common to these hinge leafs. A spiral torsion spring 4′, whose spring force acts in the opening direction of the spring, is located in the hollow pivot. The hinge pivot 10′ is fixed to a damping arrangement which damps the movement of the hinge.

The damping arrangement comprises damping wings 10-1′, 10-2′ which are arranged radially to the hinge pivot and which are located in a damping chamber 11′ filled with viscous damping material and which move against the resistance of the damping material when the hinge is moved.

One end 4-1′ of the torsion spring 4′ is form-fitted in the interior of the hollow pivot and the other end 4-2′ form-fitted to a pick-up element 6′. A setting element 6-1′ serves to set (optionally) the torsional force of the spiral torsion spring.

The damping chamber 11′ contains the damping wings. In its interior, it has a recess 11-1′ and 11-2′ for each damping wing, with corresponding radial limits (e.g. 11-1-1′, 11-1-2′), within which the damping wings move when the hinge pivot is moved. The damping material impedes the movement of the damping wings joined to the hinge pivot, as the damping material can only be forced relatively slowly through the space between the edge of the damping wing and the inner wall of the damping chamber. The more viscous the damping material and the smaller the gap between the edge of the damping wing and the inner wall of the damping chamber, and the greater the peripheral surface of the damping wing, the more the movement is impeded.

The two damping wings 10-1′ and 10-2′ are aligned radially to the hinge pivot. In the plane perpendicular to the hinge pivot, they have a cross section which is sector segment in shape, and are arranged diametrically to one another.

A bolt 13′ with a base cover 12′ and a seal 14′ serve to attach and seal the damping chamber 11′ which encloses the damping wings 10-1′ and 10-2′ in the assembled state.

Such a hinge according to the prior art has a number of drawbacks. It requires a large number of parts, a complicated assembly operation, and lacks a simple means of adjustment.

To avoid these drawbacks, the purpose of the invention is to provide a hinge with fewer parts, and which can be manufactured, assembled and adjusted more easily.

### SUMMARY OF THE INVENTION

This purpose of the invention is fulfilled by having a hinge, comprising a fixed and a moving hinge leaf, each with at least one pivot bearing, a hinge pivot common to these hinge leafs in the form of a hollow pivot, which is connected non-turnably with the first moving hinge leaf and which is located turnably in the pivot bearing of the fixed hinge leaf. A torsion spring is located in the hollow pivot of the hinge, whose torsional force acts in one direction of hinge movement, characterized in that the hollow hinge pivot and the torsion spring can be inserted as a single component into the pivot bearings of both hinge leafs, where the torsion spring is located in the hollow hinge pivot in a pre-tensioned state so that it forms a force-actuated connection with the inner wall of the hollow hinge pivot.

A further purpose of the invention is to provide a damping arrangement for rotation movements, in particular for spring-loaded hinges, which can be designed as a separate component.

The hinge according to the invention comprises a fixed hinge leaf and a moving hinge leaf, each leaf being provided with at least one pivot bearing and a hinge pivot common to the hinge leafs. The hinge pivot is in the form of a hollow pivot, the hollow pivot being connected non-turnably with the moving hinge leaf. The hollow pivot is located turnably in the pivot bearing of the fixed hinge leaf. A torsion spring is located in the hollow pivot, whose torsional force acts in one direction of hinge movement. The hollow pivot and the torsion spring are adapted to be inserted as a single component into the pivot bearings of both hinge leafs. The torsion spring is located in the hollow pivot in a pre-tensioned state so as to comprise a force-actuated connection with an inner wall of the hollow pivot.

Further, according to the invention, one end of the torsion spring projects from the hollow pivot to be connected non-turnably with a pivot-bearing end of the fixed hinge leaf and another end of the torsion spring at an end of the hollow pivot is connected non-turnably with the hollow pivot.

The one end of the torsion spring may be located in a recess in a front wall of the pivot bearing of the fixed hinge leaf. A retaining element may be fixed to the hollow pivot, the another end of the torsion spring being located in a recess in the retaining element. The retaining element may be located in the hollow pivot. The retaining element may be joined to the hollow pivot by way of a pin.

According to a further aspect of the invention, a stop may be provided for the moving hinge leaf, the stop determining an initial opening angle between the fixed leaf and the moving leaf of the hinge. The stop may be adjustably positioned on the hinge. The stop may comprise a part that is inserted in the hinge. The stop may be positioned in a manner so that the torsion spring no longer achieves a force-actuated seating in the inner wall of the hollow pivot. The stop may comprise a fixed stop combined with an additional resilient stop.

Moreover, the invention contemplates the provision of a striking surface on the fixed stop, the resilient stop comprising a spring-loaded bolt guided in the fixed stop. A head on the bolt projects from the striking surface, a spring acting on the head of the bolt. The head moves against a force of the spring in a direction of the stop when the head is subjected to force. The head may project above the striking surface on the fixed stop by an adjustable height. The at least one pivot bearing on the fixed hinge leaf comprises two pivot bearings, the at least one pivot bearing on the moving hinge leaf being located between the two pivot bearings on the fixed hinge leaf. The hollow pivot may be connected with a damping arrangement to dampen the rotation movement of the moving hinge leaf. The damping arrangement may comprise a separate component, which is connectable with the hollow pivot and the fixed hinge leaf. A retaining element may be provided on the hinge. The damping arrangement may comprise at least one exterior coupling tappet adapted to engage in at least one recess in the retaining element, in order to transmit rotational movement of the hollow pivot. Alternatively, the at least one exterior coupling tappet may comprise two coupling tappets and the at least one recess in the retaining element may comprise two recesses to receive the two coupling tappets.

The damping arrangement may have an outer dimension corresponding to the pivot bearing of the fixed hinge leaf. Furthermore, the damping arrangement may be cylindrical in shape. The pivot bearing of the moving hinge leaf may comprise interior locking grooves therein and the hollow pivot may comprise outer locking grooves thereon adapted for optional non-twisting positioning of the hollow pivot with the pivot bearing of the moving hinge leaf.

According to yet another aspect of the invention, a hinge comprises a fixed hinge leaf and a moving hinge leaf, each leaf being provided with at least one pivot bearing and a hinge pivot common to the hinge leafs. The hinge pivot is in the form of a hollow pivot, the hollow pivot being connected non-turnably with the moving hinge leaf. The hollow pivot is located turnably in the pivot bearing of the fixed hinge leaf. A torsion spring is located in the hollow pivot, whose torsional force acts in one direction of hinge movement. The hollow pivot and the torsion spring are adapted to be inserted as a single component into the pivot bearings of both hinge leafs. The torsion spring is located in the hollow pivot in a pre-tensioned state so as to comprise a force-actuated connection with an inner wall of the hollow pivot, wherein one end of the torsion spring projects from the hollow pivot to be connected non-turnably with a pivot-bearing end of the fixed hinge leaf and another end of the torsion spring at an end of the hollow pivot is connected non-turnably with the hollow pivot. A retaining element is fixed to the hollow pivot, the another end of the torsion spring being located in a recess in the retaining element. A stop is provided for the moving hinge leaf, the stop determining an initial opening angle between the fixed leaf and the moving leaf of the hinge. The stop comprises a fixed stop combined with an additional resilient stop. A striking surface is provided on the fixed stop. The resilient stop comprises a spring-loaded bolt guided in the fixed stop. A head on the bolt projects from the striking surface, a spring acting on the head of the bolt. The head moves against a force of the spring in a direction of the stop when the head is subjected to force. The at least one pivot bearing on the fixed hinge leaf comprises two pivot bearings, the at least one pivot bearing on the moving hinge leaf being located between the two pivot bearings on the fixed hinge leaf.

According to another aspect of the invention, a damping arrangement for rotational movement of a member, comprises a single-part damping chamber filled with a viscous damping material, the damping chamber having at least one interior chamber wall segment and a single-part damping-rotor insert adapted to be inserted into the damping chamber. The damping-rotor has at least one damping rotating wing movable between the chamber wall segment and at least one exterior coupling element to transmit rotational movement of the damping-rotor, and a single-part element with a seal to connect the damping chamber with the damping-rotor insert. The member may comprise a spring-loaded hinge. The single-part damping chamber may be in the shape of a pot. The viscous damping material may comprise silicone grease.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting exemplary embodiments of the present invention, in which like reference numerals represent similar parts throughout the several views of the drawings, and wherein:

FIG. 1 shows a perspective drawing of individual parts of the hinge according to the invention;

FIG. 2 shows a perspective drawing of the hinge according to the invention (with the damping arrangement) in the assembled state;

FIG. 3 shows a perspective drawing of individual parts of the hinge according to the invention with a stop removed from its inserted position;

FIG. 4 shows a perspective drawing of individual parts of the hinge according to the invention in the assembled state to show the manner in which the stop functions;

FIG. 5 shows a sectional drawing of the hinge according to the invention to show the range through which the moving hinge leaf can pivot;

FIG. 6 shows a perspective drawing of the hollow hinge pivot of the hinge according to the invention;

FIGS. 7A, 7B, 7C show perspective drawings of the retaining element of the hinge according to the invention;

FIG. 8 shows a perspective drawing of the insertable stop of the hinge according to the invention;

FIGS. 9A, 9B and 9C show drawings of the spiral torsion spring seen from various points:

FIG. 9A shows a schematic partial front view of the spiral torsion spring with retaining eyelets at its ends;

FIG. 9B shows a schematic partial top view of the spiral torsion spring;

FIG. 9C shows a schematic partial side view of the spiral torsion spring;

FIG. 10 shows the main view of a resilient stop in combination with the fixed stop (according to FIG. 1), as partial sectional view;

FIGS. 11A, 11B, 11C, and 11D show perspective views of various parts of a damping arrangement for the hinge according to the invention:

FIG. 11A shows a view of the damping chamber;

FIG. 11B shows a view of the rotor with damping wings which can be inserted into the damping chamber;

FIG. 11C shows a view of the damping chamber with rotor inserted;

FIG. 11D shows a view of the closing part for the damping chamber with rotor inserted;

FIGS. 12A, 12B, and 12C show schematic perspective drawings of a hinge with movement damping according to the state of the art:

FIG. 12A shows a schematic perspective drawing of the assembled hinge according to the state of the art;

FIG. 12B shows a schematic perspective drawing of a hinge pivot in the form of a partially hollow pivot with two damping wings at one end of the hinge and a corresponding damping chamber and a closing base for the damping chamber; and

FIG. 12C shows a schematic perspective drawing of a hinge pivot in the form of a partially hollow pivot and a spiral torsion spring.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

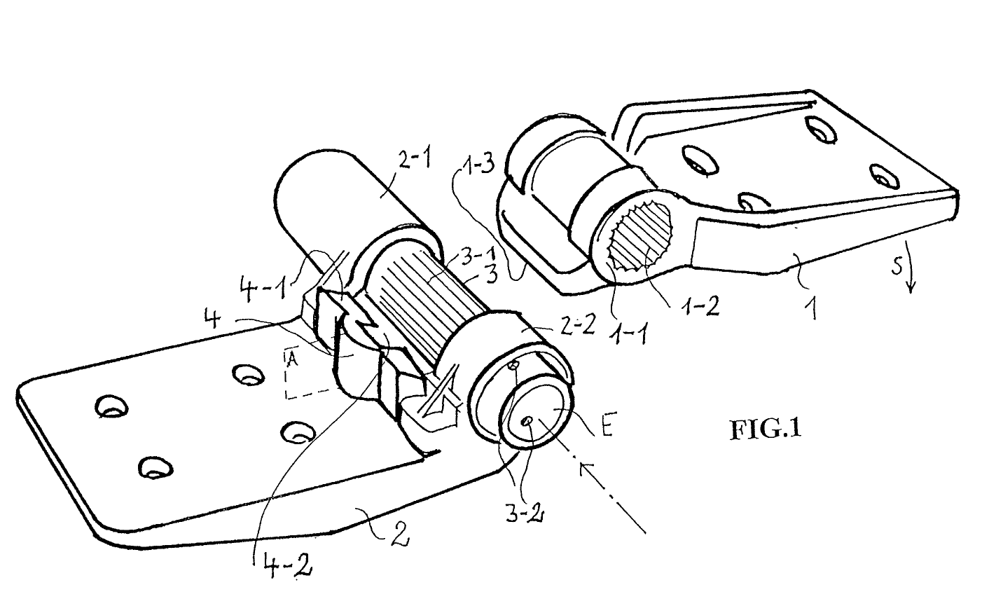

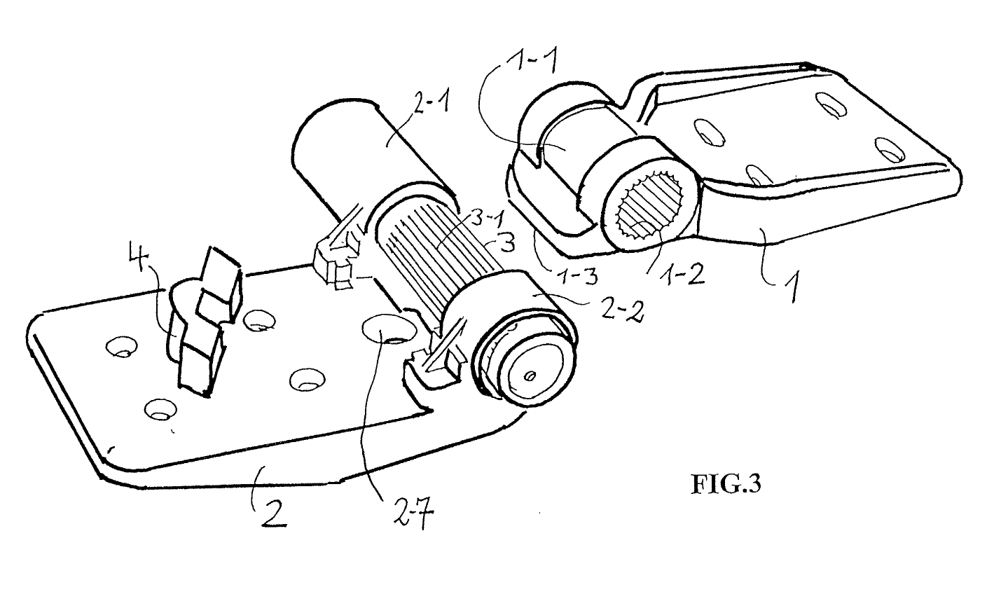

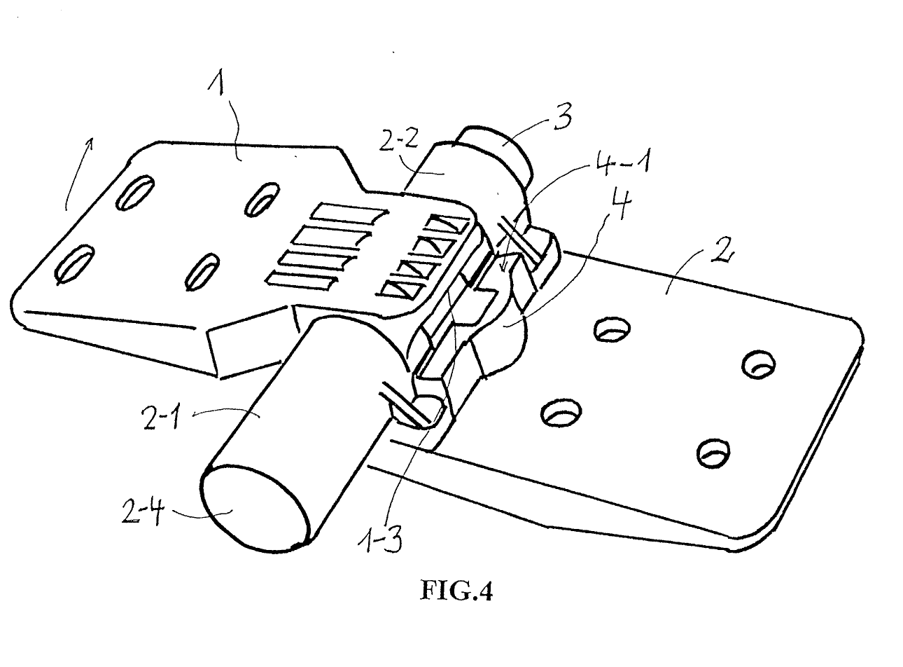

FIG. 1 shows a perspective drawing of individual parts of the hinge according to the invention. The hinge comprises a fixed hinge leaf 2 and a moving hinge leaf 1. The fixed hinge leaf 2 has two pivot bearings 2-1 and 2-2 at a distance from one another for the hollow hinge pivot 3 (see also FIG. 3 and FIG. 4).

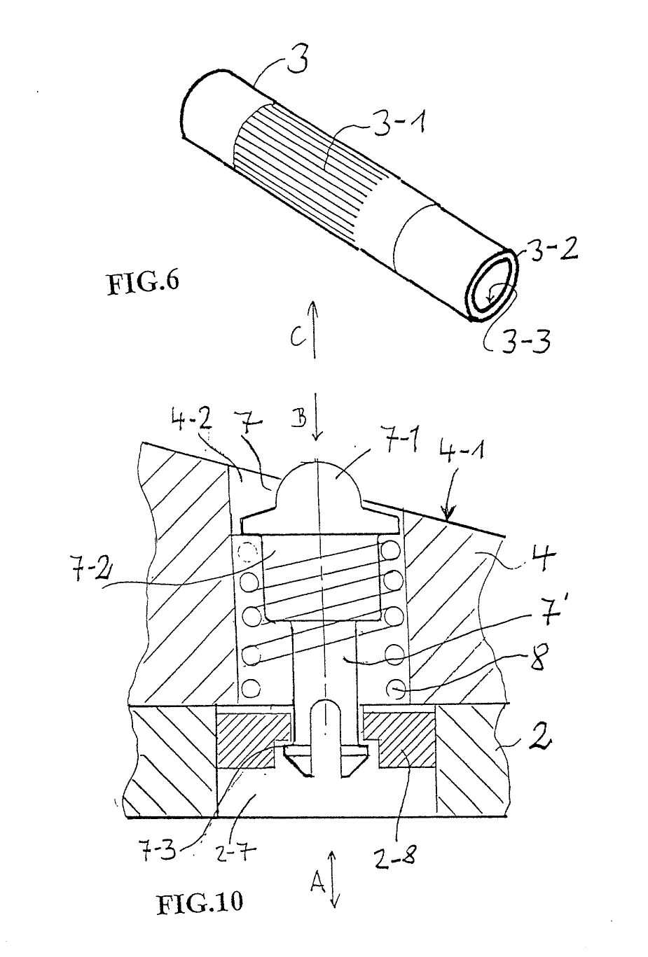

The moving hinge leaf 1 has a pivot bearing 1-1 for the hollow hinge pivot 3 which is arranged between the pivot bearings 2-1 and 2-2 of the fixed hinge leaf 2. The hollow hinge pivot 3 is located in the pivot bearings 2-1 and 2-2 in such a way that it can turn, while in the area of the pivot bearing 1-1 it is connected with this pivot bearing in such a way that it cannot turn. The non-turning joint serves for the interior interlocking 1-2 of the groove of the pivot bearing 1-1 with the outer groove interlocking 3-1 of the hollow hinge pivot 3 (see also FIG. 6).

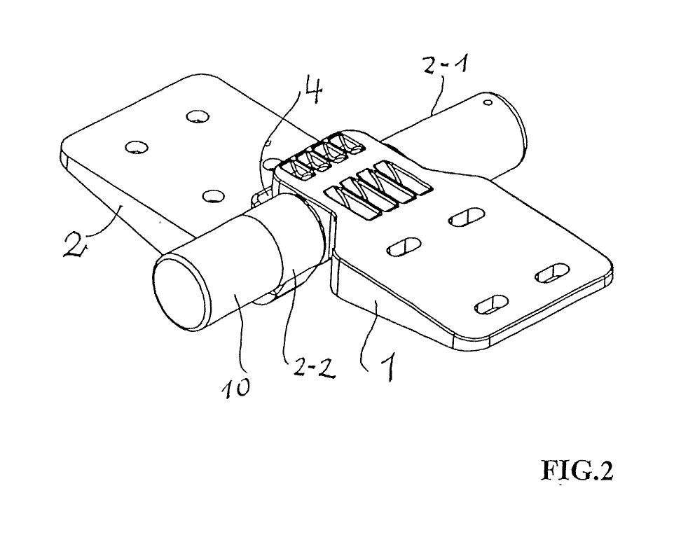

For the sake of simplicity, the fixed hinge leaf 2 in FIG. 1 is shown separately from the moving hinge leaf 1. When the hinge is being assembled, the leafs are aligned with one another in such a way (the moving hinge leaf is turned by 180 degrees, thereby producing a reciprocal arrangement of the leafs after assembly as shown in FIG. 2 and FIG. 4) that their pivot bearings are in alignment and the hollow hinge pivot 3 can be inserted into the pivot bearing in the direction of the arrow.

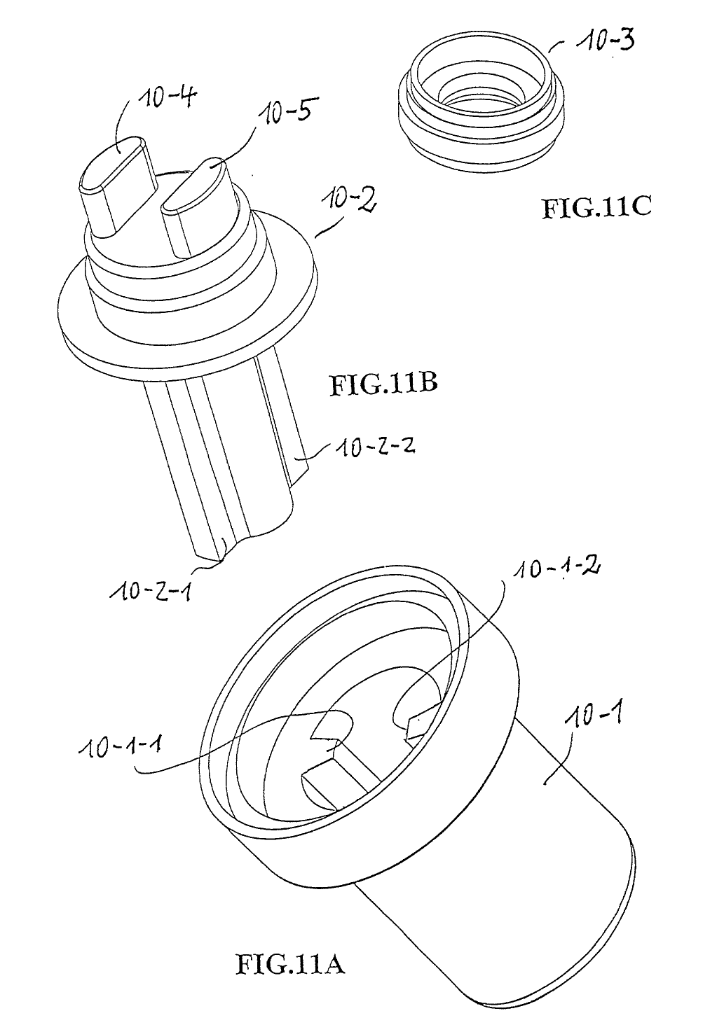

A spiral torsion spring (see FIGS. 9A, 9B and 9C) is located within the hollow hinge pivot. The assembly comprises hollow hinge pivot 3 and spiral torsion spring 6 are discussed in more detail below. The terms fixed and moving hinge leaf should be interpreted as meaning, for example, that the fixed leaf is fixed to a luggage compartment while the moving hinge leaf is connected to a moving (pivoting) luggage-compartment door.

In the assembled state of the hinge, the beginning of the pivoting angle between the moving and the fixed leaf is determined by a stop 4 for a pivoting movement in a direction S. The stop 4 is located on the fixed hinge leaf in the area between its pivot bearings 2-1 and 2-2. The surface of the stop 4-1 acts as a stop for the hinge-leaf arm 1-3 of the moving hinge leaf 1 when this is moved in the direction S. The spiral torsion spring is arranged in the hinge in such a way that its torsion force acts in the opening direction S of the hinge. In addition, applications are also possible where the spring force supports a different direction of hinge movement.

An important special feature of the hinge according to the invention is that the hollow hinge pivot 3 and the torsion spring 6 (FIG. 9A, FIG. 9B, and FIG. 9C) can be used as a common component in the pivot bearings of both hinge leafs. In this component, the torsion spring is located in the hollow hinge pivot in such a pre-tensioned state that it achieves a force-actuated seat against the interior wall of the hollow hinge pivot. The insertion of the spiral torsion spring into the hollow hinge pivot is described in more detail below.

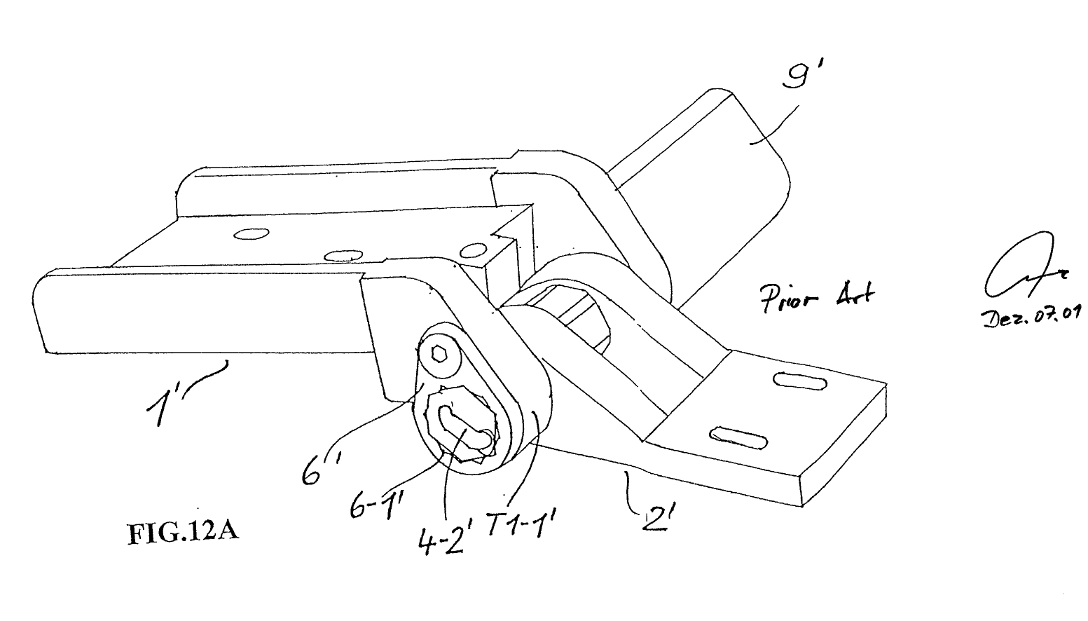

The hinge according to the invention can also be fitted with an optional damping arrangement. For this purpose, the end E of the hollow hinge pivot 3 is connected with an appropriate separate damping arrangement (FIG. 11D). The structure of such a damping arrangement and its connection with the hollow hinge pivot will be described in more detail in relation to FIG. 11.

Such a damping arrangement is not shown in FIG. 1.

The following section contains more detailed information on the spiral torsion spring, its insertion in the hollow hinge pivot and the attachment of the component of the hollow hinge pivot 3 and the spiral torsion spring in the hinge.

FIG. 9 shows the spiral torsion spring 6 in a number of different views. FIG. 9A shows a schematic partial front view of the spiral torsion spring with retaining eyelets 6-1 and 6-2 at its ends. FIG. 9B shows a schematic partial top view of the spiral torsion spring. FIG. 9C shows a schematic side view of the spiral torsion spring.

The spiral torsion spring 6 has a number of coils. At each end, the spiral torsion spring has a diagonally placed end piece 6-1 and 6-2 with retaining eyelet which serves to ensure the subsequent non-twist form-fitting fastening of the spring in an appropriate holder.

FIG. 6 shows a perspective drawing of the hollow hinge pivot 3 of the hinge according to the invention. As already indicated, the hollow hinge pivot has exterior groove teeth 3-1 for a non-turning interlock with the interior groove teeth 1-2 in the pivot bearing. The hollow hinge pivot has an interior diameter which is smaller than the outer diameter of the spiral torsion spring 6 in its untensioned state, i.e. in its untensioned state, the spiral torsion spring 6 cannot be inserted into the hollow hinge pivot. The spiral torsion spring can only be introduced into the hollow hinge pivot when it has been pre-tensioned (twisted, torsioned) until its outer diameter is sufficiently reduced to allow its insertion (in this pre-tensioned state) into the hollow hinge pivot.

When the tensioning force is released from the spiral torsion spring, it releases inside the hollow hinge pivot causing its outer diameter to expand, thereby creating a force-actuated connection with the interior wall of the hollow hinge pivot. The hollow hinge pivot and the spiral torsion spring pressing against its interior wall now form one component which can easily be inserted into the pivot bearing.

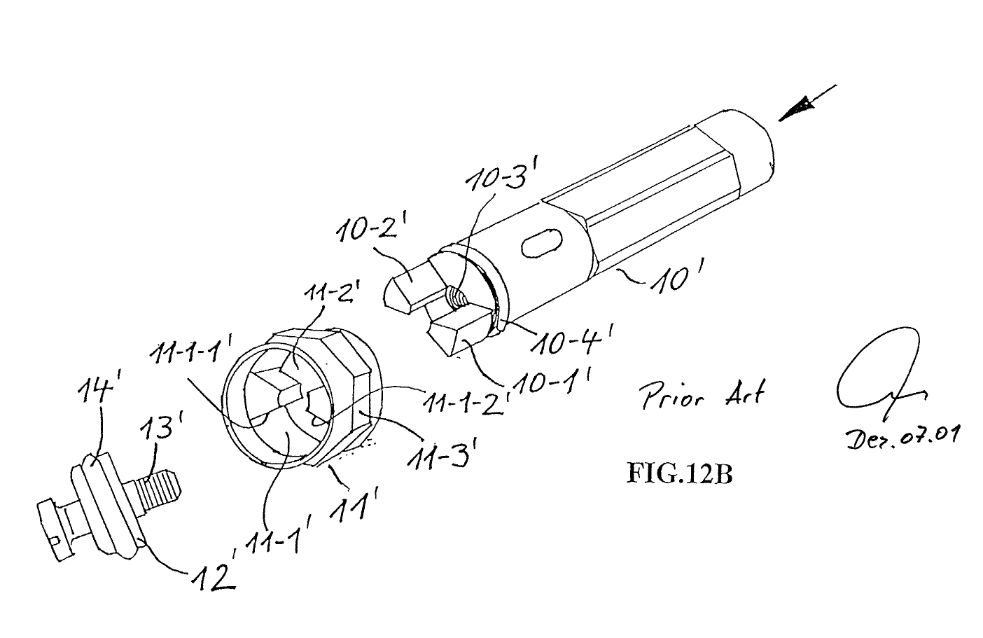

The time required for assembling the above component is substantially less than that for the arrangement according to the prior art shown in FIG. 12.

The pre-tensioned spiral torsion spring can be inserted for example, with the assistance of a long-shafted rotating mandrel. The hollow hinge pivot is pushed onto the upper part of the shaft and the spiral torsion spring onto the lower part. One end of the spiral torsion spring is fixed to the mandrel, the other in an external holder. The mandrel is then rotated until the outer diameter of the spiral torsion spring has been sufficiently reduced by the increasing tensioning force, and the hollow hinge pivot can be pushed over the spiral torsion spring.

In the assembly of the hollow hinge pivot 3 and spiral torsion spring 6, an end piece 6-1 with a retaining eyelet projects at one end of the hollow hinge pivot. The assembly is inserted into the pivot bearings of the hinge leafs in such a way that this eyelet on the end piece 6-1 hooks into a recess (not shown) on the inside of the front wall 2-4 of the pivot bearing 2-1.

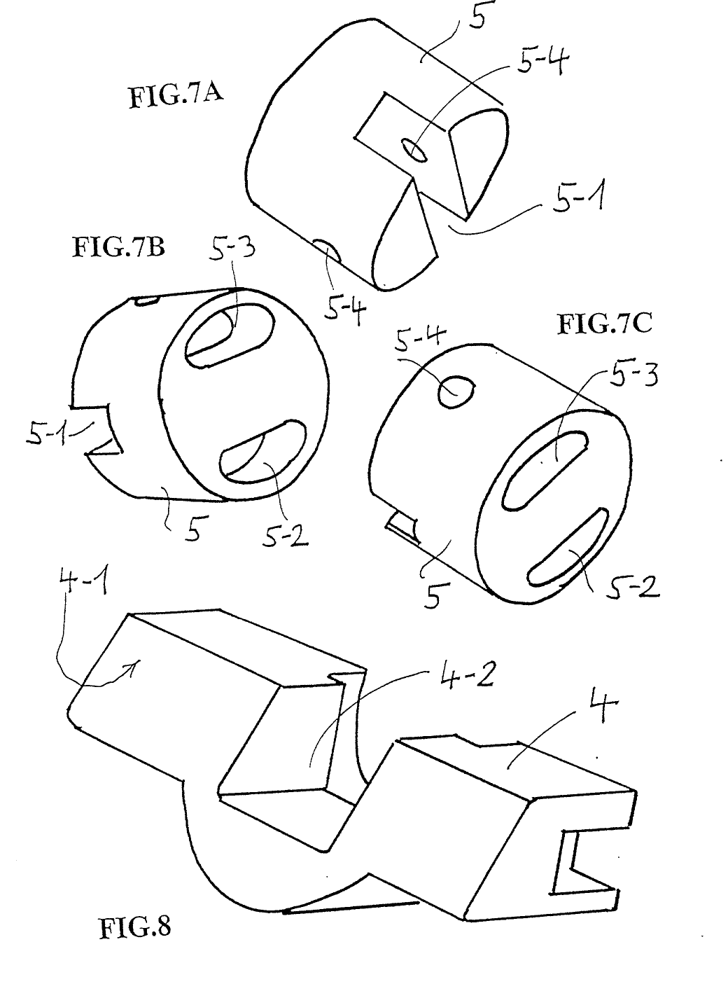

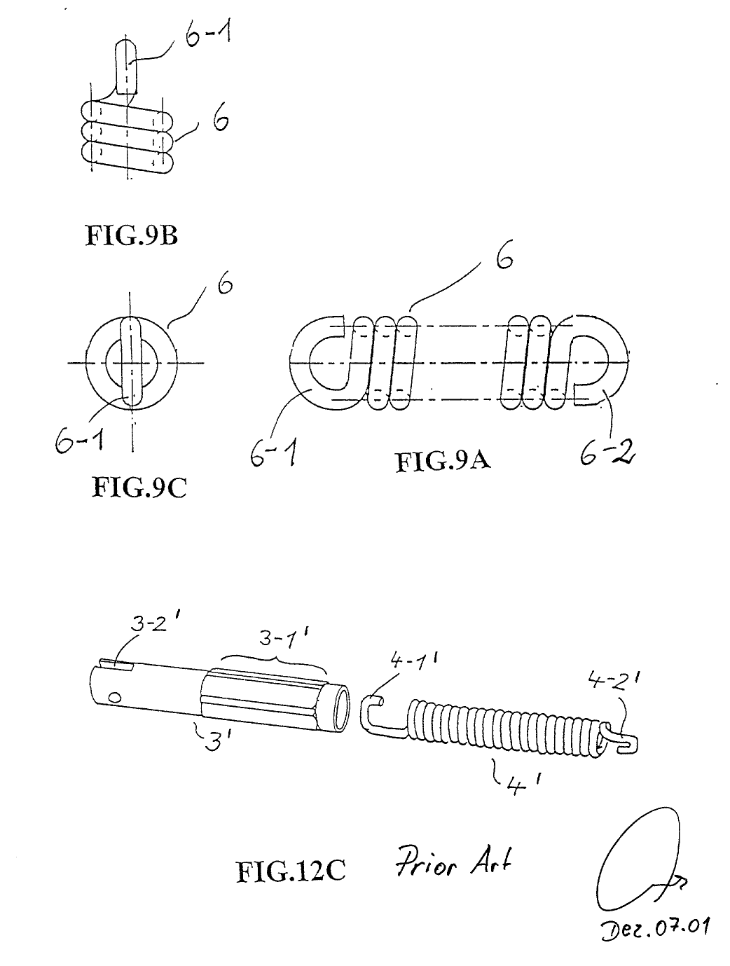

The other eyelet end piece 6-2 of the spiral torsion spring is fixed in the interior of the hinge pivot near its end E with the assistance of the retaining element 5 (FIG. 7) as described below.

FIGS. 7A, 7B and 7C show various perspective drawings of the retaining element 5 of the hinge according to the invention. The retaining element 5 serves to attach the eyelet end piece 6-2 of the spiral torsion spring 6 within the hollow hinge pivot 3. The retaining element 5 is cylindrical in shape to allow it to be inserted easily into the hollow hinge pivot 3. It has a recess 5-1 at one end to receive the retaining-eyelet end 6-2 of the spiral torsion spring 6.

In addition, the retaining element 5-4 has a hole, which, together with two holes 3-2 (FIG. 1) located diametrically opposite one another in the hollow hinge pivot, receives a pin intended to achieve a twist-free connection between the retaining element and the hollow hinge pivot 3.

The two diametrically arranged recesses 5-2 and 5-2 in the front of the retaining element, serve to “couple” on the separate damping arrangement 10 (FIG. 11D). Details of this are given in connection with FIGS. 11A, 11B and 11D.

After insertion of the assembly comprising the hollow hinge pivot 3 and spiral torsion spring 6 in the pivot bearings of both hinge leafs with the moving hinge leaf in the pivoted position, the stop 4 is located on the fixed hinge leaf 2. The stop (4) is designed preferably as an insertable part (with locking spring-loaded retaining lugs, not shown). The fixed stop 4 has two effects. First, it serves to stop the movement of the moving hinge leaf when this is moved against the pivoting direction S. In addition, the position of the stop is selected in such a way that the spiral torsion spring in the interior of the hollow hinge pivot 3 can no longer achieve a fixed force-actuated seat against its interior wall. The beginning of the pivoting range therefore does not coincide with the force-actuated seat of the spiral torsion spring on the inside of the hollow hinge pivot.

The beginning of the opening and pivoting range of the moving hinge leaf can therefore be varied by altering the stop position. Different stop positions can therefore be achieved, for example, by adjustable stops or similar devices.

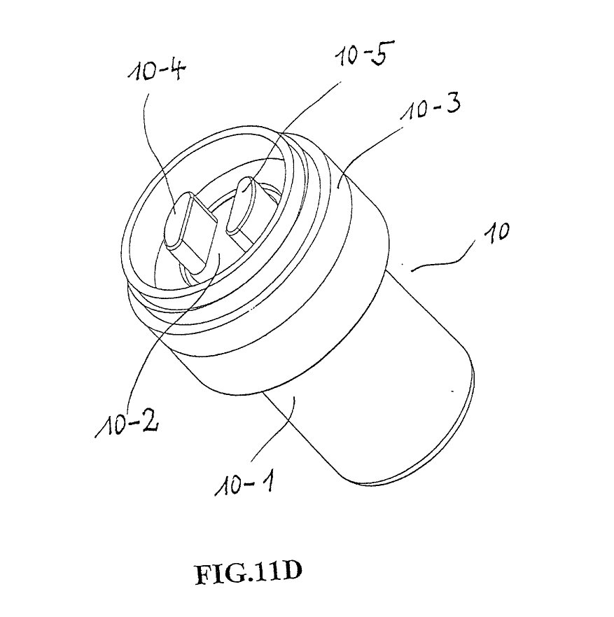

In a special version of the hinge according to the invention, the fixed stop 4 with its stop surface 4-1 is combined with an additional resilient stop 7 (FIG. 10).

FIG. 10 shows the main view of a resilient stop 7 in combination with the fixed stop 4 (according to FIG. 1), in partial sectional view. In FIG. 10, the fixed stop 4 and the fixed hinge leaf 2 is shown in a partial sectional view according to section plane A (FIG. 1). The fixed stop 4 has a recess 4-2 which lies above the hole 2-7 (FIG. 3) in the fixed hinge leaf 2. In this hole 2-7, an adjustable threaded insert 2-8 is located (simplified representation), which can be adjusted in a direction of arrow A. In the recess 4-2 and in the opening of the threaded insert, a spring 8 and spring-loaded bolt 7′ are located, which can be moved in a direction of arrow B. The “round head” 7-1 of this spring-loaded bolt 7′ projects from the stop surface 4-1 of the fixed stop 4. When the spring-loaded bolt is subjected to a force in the direction of arrow B by the moving hinge leaf, the bolt 7′ moves in the direction of arrow B against the force of the spring 8. Thus, this spring-loaded stop 7 acts as a kind of resilient “pre-stop” before the moving hinge leaf contacts the surface 4-1 of the fixed stop 4.

The upper part 7-2 of the bolt 7′ (here approximately rectangular) is adapted to the shape of the recess 4-2. The force of the spring 8 acting in a direction of arrow C presses the unloaded bolt into a position where its projection 7-3 strikes the threaded insert 2-8.

By adjusting (setting) the threaded insert 2-8, it is possible to define how far the round head 7-1 should project from the stop surface 4-1. Besides this, it is also possible to align the doors of adjacent luggage compartments (e.g. in aircraft) with one another by adjusting the threaded insert.

FIGS. 11A, 11B, 11C and 11D show perspective views of various parts of the damping arrangement 10 for the hinge according to the invention. FIG. 11A shows a view of the damping chamber 10-1. FIG. 11B shows a view of the rotor insert 10-2 with damping wings 10-2-1 and 10-2-2 which can be inserted into the damping chamber. FIG. 11C shows a view of the closing part 10-2 for the damping chamber with a rotor inserted. FIG. 11D shows a view of the closing part of the assembled damping arrangement 10.

The principle of this damping arrangement corresponds to that already known from the prior art (FIG. 12).

A significant difference in the design of the damping arrangement is that the damping arrangement 10 for the hinge according to the invention is a separate part which is quite distinct from the hollow hinge pivot. The damping arrangement 10 is joined to the hollow hinge pivot by a simple mechanism when the hinge is being assembled.

As already described with reference to the retaining element 5 (FIG. 7), it has two recesses 5-2, 5-3. These serve to receive the two coupling tappets 10-4 and 10-5 of the damping arrangement 10 (FIG. 11D) for transmitting the rotation movement of the hollow hinge pivot.

FIGS. 11A, 11B, 11C and 11D show perspective views of various parts of the damping arrangement 10 for the hinge according to the invention. The damping arrangement 10 comprises a single-part damping chamber 10-1 similar in shape to a cylindrical pot, with interior chamber wall segments 10-1-1 and 10-1-2, a single-part damping-rotor insert 10-2 with two damping wings 10-2-1 and 10-2-2 which is inserted into the damping chamber, two exterior coupling elements 10-4 and 10-5 (for connection with the retaining element 5 in the hollow cylinder pivot), and a single-part element 10-3 with a sealing ring for connecting and sealing the damping chamber 10-3 with the rotor insert 10-2.

The exterior of the damping arrangement 10 has a cylindrical shape which corresponds to the pivot bearing 2-2 of the fixed hinge leaf 2. When the damping arrangement 10 has been “coupled” to the retaining element 5 in the hollow hinge pivot, the damping arrangement is joined to the pivot bearing of the fixed hinge leaf, preferably by adhesive bonding or a similar process. It should also be noted that the damping arrangement can also be connected by other elements equivalent to the coupling elements 10-4, 10-5 and 5-3, 5-2.

FIG. 2 shows a perspective drawing of the hinge according to the invention with the damping arrangement 10 in the assembled state.

FIG. 4 shows a perspective drawing of individual parts of the hinge according to the invention in the assembled state to show the manner in which the stop 4 acts. If the moving hinge leaf 1 is pivoted in the direction of the arrow T, the movement is stopped when the projection 1-3 of the moving hinge leaf 1 meets the surface 4-1 of the fixed stop 4.

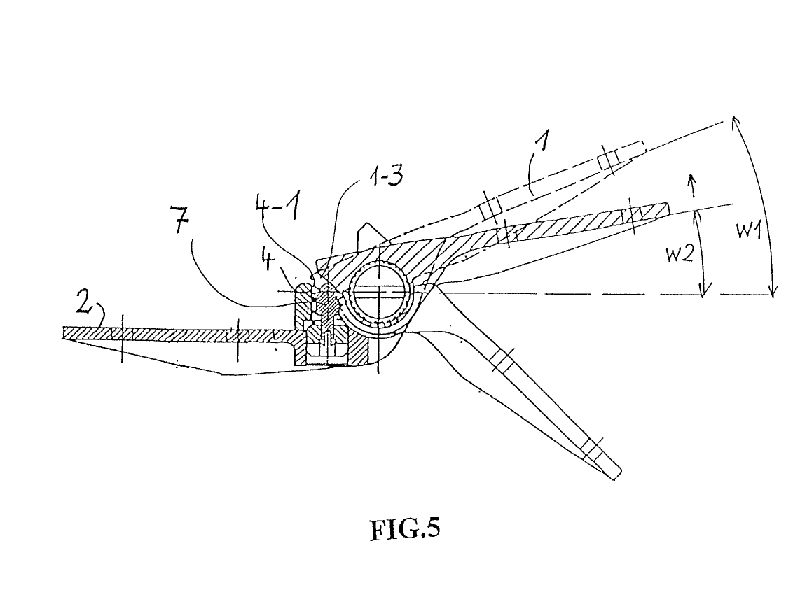

FIG. 5 shows a sectional drawing of the hinge according to the invention to show the range through which the moving hinge leaf 1 can pivot in combination with the spring-loaded stop 7 and the fixed stop 4. When the projection 1-3 of the moving hinge leaf 1 meets the head 7-1 of the spring-loaded stop 7, the moving hinge leaf assumes an angular position w2 with reference to the fixed hinge leaf 2. When the hinge leaf 1 continues its movement in the direction of arrow N, the spring-loaded stop 7 is pressed in still further, until the projection 1-3 of the moving hinge leaf 1 meets the fixed stop 4. This stop position is designated by the angle position w1. All parts of the hinge with the exception of the spiral torsion spring are made preferably of plastic.

The purpose of the invention is fulfilled by having a hinge, comprising a fixed and a moving hinge leaf, each with at least one pivot bearing, a hinge pivot common to these hinge leafs in the form of a hollow pivot, which is connected non-turnably with the first moving hinge leaf and which is located turnably in the pivot bearing of the fixed hinge leaf. A torsion spring is located in the hollow pivot of the hinge, whose torsional force acts in one direction of hinge movement, characterized in that the hollow hinge pivot 3 shown in FIG. 6 and the torsion spring 6 shown in FIG. 9A can be inserted as a single component into the pivot bearings 2-1, 1-1, 2-2 of both hinge leafs 2,1, where the torsion spring 6 is located in the hollow hinge pivot 3 in a pre-tensioned state so that it forms a force-actuated connection with the inner wall of the hollow hinge pivot 3.

According to another aspect of the invention, one end 6-1 of the torsion spring projecting from the hollow hinge pivot is connected non-turnably with the pivot-bearing end of the fixed hinge leaf 2 and the other end 6-2 of the torsion spring at the end E of the hollow hinge pivot is connected non-turnably with the hollow hinge pivot 3.

The end 6-1 of the torsion spring is located in a recess in the front wall 2-4 of the pivot bearing 2-1 of the fixed hinge leaf.

The end 6-2 of the torsion spring is located in a recess 5-1 in a retaining element 5 as shown in FIG. 7A which is fixed to the hollow hinge pivot 3. The retaining element 5 is located in the hollow hinge pivot 3. The retaining element 5 is joined to the hollow hinge pivot 3 by way of a pin. A stop 4 is provided for the moving hinge leaf 1 by which the beginning of the opening angle w1 between the fixed leaf 2 and the moving leaf 1 of the hinge is determined.

The stop position 4-1 of the stop 4 is adjustable. The stop 4 may be an inserted part. The position of the stop 4-1 is such that the torsion spring 6 in the hollow hinge pivot 3 no longer achieves a force-actuated seating in the inner wall of the hollow hinge pivot 3.

The stop 4 is a fixed stop which is combined with an additional resilient stop 7 as shown in FIG. 10.

The resilient stop 7 has a spring-loaded bolt 7′ which is guided in the fixed stop 4, and whose head 7-1 projects from the striking surface 4-1 of the fixed stop 4, and when the head is subjected to force by the striking part of the bolt 7′, it moves against the force of the spring 8 in the direction B of the stop.

The height of the head 7-1 projecting above the striking surface 4-1 of the fixed stop 4 of the bolt 7′ is adjustable.

The fixed hinge leaf 2 has two pivot bearings 2-1, 2-2 between which at least one pivot bearing 1-1 of the moving hinge leaf 1 is located.

The hollow hinge pivot is connected with a damping arrangement 10 to damp the rotation movement of the moving hinge leaf 1.

The damping arrangement 10 shown in FIG. 11D is a separate component, which is connectable with the hollow hinge pivot 3 and the fixed hinge leaf 2.

The damping arrangement 10 has at least one exterior coupling tappet 10-4, 10-5 which can be located in a recess 5-2, 5-3 in the retaining element which is intended for the tappet, in order to transmit the rotation movement of the hollow hinge pivot.

The damping arrangement 10 may have two coupling tappets 10-4, 10-5 and the retaining element 5 may have two recesses 5-2, 5-3 to receive the coupling tappets.

The damping arrangement 10 has an outer dimension corresponding to the pivot bearing 2-2 of the fixed hinge leaf 2.

The damping arrangement 10 is cylindrical in shape.

The pivot bearing 1-1 of the moving hinge leaf 1 has interior locking grooves 1-2 and the hollow hinge pivot 3 has outer locking grooves 3-1 for optional non-twisting positioning of the hollow hinge pivot with the pivot bearing.

According to a further aspect of the invention, the damping arrangement for a rotation movement, especially for a spring-loaded hinge movement, is characterized by a single-part damping chamber 10-1 resembling a pot which is filled with a viscous damping material, preferably silicone grease, and which has at least one interior chamber wall segment 10-1-1, 10-1-2, a single-part damping-rotor insert 10-2 which can be inserted into the damping chamber 10-1 and which has at least one damping rotating wing 10-2-1, 10-2-2 which can be moved between the chamber wall element and at least one exterior coupling element 10-4, 10-5 to transmit the rotation movement, and a single-part element 10-3 with seal to connect the damping chamber 10-1 with the damping-rotor insert 10-2.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A hinge comprising:
a fixed hinge leaf;
a moving hinge leaf;
each leaf being provided with at least one pivot bearing;
a hinge pivot common to said hinge leafs;
said hinge pivot being in the form of a hollow pivot;
said hollow pivot being connected non-turnably with the moving hinge leaf;
said hollow pivot being located turnably in the pivot bearing of the fixed hinge leaf;
a torsion spring located in said hollow pivot, whose torsional force acts in one direction of hinge movement,
wherein the hollow pivot and the torsion spring are adapted to be inserted as a single component into the pivot bearings of both hinge leafs;
said torsion spring being located in the hollow pivot in a pre-tensioned state so as to comprise a force-actuated connection with an inner wall of said hollow pivot.

2. The hinge according to claim 1, wherein one end of said torsion spring projects from said hollow pivot to be connected non-turnably with a pivot-bearing end of the fixed hinge leaf and another end of said torsion spring at an end of the hollow pivot is connected non-turnably with the hollow pivot.

3. The hinge according to claim 2, wherein said one end of the torsion spring is located in a recess in a front wall of the pivot bearing of the fixed hinge leaf.

4. The hinge according to claim 2, further comprising:
a retaining element fixed to the hollow pivot, said another end of the torsion spring being located in a recess in said retaining element.

5. The hinge according to claim 4, wherein said retaining element is located in said hollow pivot.

6. The hinge according to claim 4, wherein said retaining element is joined to said hollow pivot by way of a pin.

7. The hinge according to claim 1, further comprising a stop for said moving hinge leaf, said stop determining an initial opening angle between the fixed leaf and the moving leaf of the hinge.

8. The hinge according to claim 7, wherein said stop is adjustably positioned on said hinge.

9. The hinge according to claim 7, wherein the stop comprises a part that may be inserted in said hinge.

10. The hinge according to claim 7, wherein the stop is positioned in a manner so that the torsion spring no longer achieves a force-actuated seating in the inner wall of the hollow pivot.

11. The hinge according to claim 7, wherein the stop comprises a fixed stop combined with an additional resilient stop.

12. The hinge according to claim 11, further comprising:
a striking surface on said fixed stop;
said resilient stop comprising a spring-loaded bolt guided in said fixed stop;
a head on said bolt which projects from said striking surface;
a spring acting on the head of said bolt;
the head moving against a force of the spring in a direction of the stop when the head is subjected to force.

13. The hinge according to claim 12, wherein the head projects above the striking surface on said fixed stop by an adjustable height.

14. The hinge according to claim 1, wherein said at least one pivot bearing on the fixed hinge leaf comprises two pivot bearings, said at least one pivot bearing on the moving hinge leaf being located between said two pivot bearings on the fixed hinge leaf.

15. The hinge according to claim 1, wherein the hollow pivot is connected with a damping arrangement to dampen the rotation movement of the moving hinge leaf.

16. The hinge according to claim 15, wherein the damping arrangement comprises a separate component, which is connectable with the hollow pivot and the fixed hinge leaf.

17. The hinge according to claim 16, further comprising a retaining element on said hinge;
the damping arrangement comprising at least one exterior coupling tappet adapted to engage in at least one recess in the retaining element, in order to transmit rotational movement of the hollow pivot.

18. The hinge according to claim 17, wherein said at least one exterior coupling tappet comprise two coupling tappets and said at least one recess in the retaining element comprises two recesses to receive the two coupling tappets.

19. The hinge according to claim 16, wherein the damping arrangement has an outer dimension corresponding to the pivot bearing of the fixed hinge leaf.

20. The hinge according to claim 19, wherein the damping arrangement is cylindrical in shape.

21. The hinge according to claim 1, wherein the pivot bearing of the moving hinge leaf comprises interior locking grooves therein and the hollow pivot comprises outer locking grooves thereon adapted for optional non-twisting positioning of the hollow pivot with the pivot bearing of the moving hinge leaf.

22. A hinge comprising:
a fixed hinge leaf;
a moving hinge leaf;
each leaf being provided with at least one pivot bearing;
a hinge pivot common to said hinge leafs;
said hinge pivot being in the form of a hollow pivot;
said hollow pivot being connected non-turnably with the moving hinge leaf;
said hollow pivot being located turnably in the pivot bearing of the fixed hinge leaf;
a torsion spring located in said hollow pivot, whose torsional force acts in one direction of hinge movement,
wherein the hollow pivot and the torsion spring are adapted to be inserted as a single component into the pivot bearings of both hinge leafs;
said torsion spring being located in the hollow pivot in a pre-tensioned state so as to comprise a force-actuated connection with an inner wall of said hollow pivot, wherein one end of said torsion spring projects from said hollow pivot to be connected non-turnably with a pivot-bearing end of the fixed hinge leaf and another end of said torsion spring at an end of the hollow pivot is connected non-turnably with the hollow pivot;
a retaining element fixed to the hollow pivot, said another end of the torsion spring being located in a recess in said retaining element;
a stop for said moving hinge leaf, said stop determining an initial opening angle between the fixed leaf and the moving leaf of the hinge;
the stop comprising a fixed stop combined with an additional resilient stop;
a striking surface on said fixed stop;
said resilient stop comprising a spring-loaded bolt guided in said fixed stop;
a head on said bolt which projects from said striking surface;
a spring acting on the head of said bolt;
the head moving against a force of the spring in a direction of the stop when the head is subjected to force; and
said at least one pivot bearing on the fixed hinge leaf comprising two pivot bearings, said at least one pivot bearing on the moving hinge leaf being located between said two pivot bearings on the fixed hinge leaf.

23. Damping arrangement for rotational movement of a member comprising:
a single-part damping chamber filled with a viscous damping material;
at least one interior chamber wall segment in said damping chamber;
a single-part damping-rotor insert adapted to be inserted into the damping chamber;
at least one exterior coupling element;
at least one damping rotating wing in said damping-rotor, said at least one damping rotating wing being movable between the chamber wall segment and said at least one exterior coupling element to transmit rotational movement of the damping-rotor; and
a single-part element with a seal to connect the damping chamber with the damping-rotor insert.

24. The damping arrangement according to claim 22, wherein the member comprises a spring-loaded hinge.

25. The damping arrangement according to claim 22, wherein said single-part damping chamber is in the shape of a pot.

26. The damping arrangement according to claim 22, wherein said viscous damping material comprises silicone grease.
